(19) United States
(12) Patent Application Publication
(10) Pub. No.: US 2012/0140593 A1
(43) Pub. Date: Jun. 7, 2012

(54) TIME-LAPSE SEISMIC COMPARISONS USING PRE-STACK IMAGING AND COMPLEX WAVE FIELD COMPARISONS TO IMPROVE ACCURACY AND DETAIL

(76) Inventors: Paul L. Stoffa, Spicewood, TX (US); Roustam Seif, Austin, TX (US)

(21) Appl. No.: 13/390,572

(22) PCT Filed: Sep. 15, 2010
(86) PCT No.: PCT/US10/48848

§ 371 Date: Feb. 15, 2012

Related U.S. Application Data
(60) Provisional application No. 61/243,432, filed on Sep. 17, 2009.

(51) Int. Cl. G01V 1/28

(52) U.S. Cl. 367/38

(57) ABSTRACT

A method, computer program product and system for improving the accuracy and detail in determining changes in properties associated with sub-surface geological structures. A first and a second time-lapse seismic data taken for a first and a second seismic survey, respectively, are received. If no calibration for the first and second time-lapse seismic data are needed, then an absolute time-lapse comparison is made. In the absolute time-lapse comparison, the time-lapse seismic data taken at a depth level below a reference level is compared with time-lapse seismic data taken at the reference level. If however, calibration is needed, then a residual time-lapse comparison is made. In the residual time-lapse comparison, the derived residual phase and amplitude differences at a depth level below the reference level are compared with the derived residual phase and amplitude differences at the reference level.

### CROSS REFERENCE TO RELATED APPLICATIONS

This application is related to the following commonly owned co-pending U.S. Patent Application:

Provisional Patent Application Ser. No. 61/243,432, “Time-Lapse Seismic Comparisons Using Pre-stack Imaging and Complex Wave Field Comparisons to Improve Accuracy and Detail,” filed Sep. 17, 2009, and claims the benefit of its earlier filing date under 35 U. S .C. §119(e).

### TECHNICAL FIELD

The present invention relates to seismic data processing and imaging, and more particularly to processing, imaging and comparison of time-lapse seismic data for two or more repeated seismic surveys.

### BACKGROUND

Seismic data are typically used to identify and/or characterize the geologic structures, such as oil and gas reservoirs, underlying the earth's surface. Seismic data may be acquired by: (1) generating elastic wave energy at a multiplicity of locations at or near the earth's surface, or within the subsurface; (2) transmitting the generated elastic wave energy into the earth's subsurface where properties associated with the underlying geological structures affect (reflect and/or refract) the transmitted wave energy; and (3) recording the affected, elastic wave energy received at a multiplicity of receiver locations at or near the earth's surface, or within the subsurface. Seismic data processing methods apply a range of digital signal processing algorithms to the recorded data to produce an elastic wavefield image that delineates the effects of the underlying geologic structures upon the wave as the wave propagated through the earth's subsurface. These delineations are then used to draw conclusions about the underlying geological structures.

In many cases, the ability to manage the production of, for example, an oil reservoir is enhanced by an understanding of the ways in which the properties of the underlying geological structures associated with the reservoir have changed over time. For instance, the removal of oil from a location in a reservoir may have, over time, changed the elastic rock properties associated with that location of the reservoir. Knowing that these changes have occurred may be useful in identifying the location at which another well should be placed to realize better production from the reservoir than if the information had not been known.

Currently, a process referred to herein as “time-lapse” seismic surveying is used to facilitate the acquisition of information on changes in the properties associated with subsurface geological structures. Time-lapse seismic surveying involves obtaining seismic data of the same part of the subterranean formation at different times (e.g., obtain seismic data of the same part of the subterranean formation a year apart). It allows studying the changes in seismic properties of the formation as a function of time due to, for example, fluid flow through the underground formation, spatial and temporal variation in fluid saturation, pressure and temperature. The seismic data obtained from time-lapse surveying can be combined to generate images. These images (images of the subterranean formation at different times) can be compared to illustrate any changes that have occurred.

However, these images may contain inaccuracies and/or loss of detail as a result of the process in generating these images from the time-lapse seismic data.

Therefore, there is a need in the art for improving the accuracy and detail in determining the changes in the properties associated with subsurface geological structures using time-lapse seismic data.

### BRIEF SUMMARY

In one embodiment of the present invention, a method for improving the accuracy and detail in determining changes in properties associated with subsurface geological structures using time-lapse seismic data comprises receiving a first and a second pre-processed time-lapse seismic data from a first and a second seismic survey. The method further comprises recovering complex source and receiver wave fields from the first and second pre-processed time-lapse seismic data at a reference level. Additionally, the method comprises forming a first and a second pre-image wave field for the first and second seismic surveys at the reference level. In addition, the method comprises performing an absolute time-lapse seismic comparison if the first and second pre-processed time-lapse seismic data do not need to be normalized. The absolute time-lapse comparison comprises comparing phase and amplitude differences between one or more time-lapse seismic data after downward continuation to a depth level below the reference level with one of the first and second pre-processed time-lapse seismic data. The reference level is located above a region of interest below the subsurface.

In another embodiment of the present invention, a method for improving the accuracy and detail in determining changes in properties associated with subsurface geological structures using time-lapse seismic data comprises receiving a first and a second pre-processed time-lapse seismic data from a first and a second seismic survey. The method further comprises recovering complex source and receiver wave fields from the first and second pre-processed time-lapse seismic data at a reference level. Additionally, the method comprises forming a first and a second pre-image wave field for the first and second seismic surveys at the reference level. In addition, the method comprises performing a residual time-lapse seismic comparison if the first and second pre-processed time-lapse seismic data need to be normalized. The residual time-lapse comparison comprises normalizing one or more time-lapse seismic data at the reference level using a phase and an amplitude difference between the first and second pre-image wave fields to derive a relative comparison measure. Furthermore, the residual time-lapse comparison comprises comparing the one or more normalized time-lapse seismic data after downward continuation to a depth level below the reference level with one of the first and second pre-processed time-lapse seismic data. The reference level is located above a region of interest below the subsurface.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates the absolute comparison process between two repeated seismic surveys in accordance with an embodiment of the present invention;

FIG. 2 illustrates the residual comparison process between two repeated seismic surveys in accordance with an embodiment of the present invention;

FIG. 3 illustrates schematically the basic principles used in seismic acquisition in accordance with an embodiment of the present invention;

FIG. 4 depicts an embodiment of a hardware configuration of a computer system which is representative of a hardware environment for practicing the present invention; and

FIG. 5 is a flowchart of a method for improving the accuracy and detail in determining changes in properties associated with subsurface geological structure using time-lapse seismic data in accordance with an embodiment of the present invention

### DETAILED DESCRIPTION

Seismic data are acquired to generate subsurface images of geologic structures. In the industrial application of the methods of the present invention, the goal is to detect structures favorable to the accumulation of hydrocarbons. The methods of the present invention include a source of acoustic or elastic energy being excited somewhere in the medium, usually near the surface but other depths are possible. The energy which transmits into the subsurface and reflects or scatters back is collected by a series of detectors, the recording array or arrays. The collected data may be multi component (particle velocities or accelerations) or simply vertical particle velocity or pressure. The source of excitation is then moved, and the recording arrays may or may not be moved. The process is repeated. The idea is to illuminate the subsurface target with as many sources of energy as economically possible and to record as much of the scattered wave field as possible from each source.

Time-lapse seismic surveying is based on repeated seismic surveys, which are designed to be as similar as possible. At least two surveys may be required. The source amplitudes, frequency response, and the detectors are deployed so as to be as identical as possible in the repeated surveys. A system for calibration may also be installed and used to detect differences in response and develop filters for correction purposes. Even so, corrections are often needed for noise, and filters may need to be defined before comparisons are made. Sometimes the detectors are permanently installed to eliminate variability in the recordings due to variations in receiver positions or response. The methods of the present invention are used to detect changes in reservoir properties and to use these for optimizing production. The assumptions are that if the seismic data are repeatable or made so after proper filtering and calibration, the changes in the recorded response are due to changes in fluid content, since the rock formation within which the fluids are contained has not changed significantly during the time interval between the seismic surveys. During the production of a reservoir, the fluid properties that are of interest include the pressure and the saturation. The application of time-lapse seismic surveying can be generalized however. That is, it can be used to detect any type of subsurface change between the repeated surveys. These might be due to geomechanical effects in the rock formations above a reservoir or aquifer that are being produced, or to changes due to fluid injection for production purposes and for applications such as CO₂ sequestration. In addition to human induced environmental changes, naturally occurring changes can also be detected and/or monitored.

In all approaches, one seismic survey serves as a reference for the second and further repeat seismic surveys. For reservoir monitoring, the goals are to detect the changes in fluid pathways, to monitor the evolution of the reservoir, and to modify production strategies to optimize recovery.

Methods applied to perform these comparisons after calibration include subtracting the seismic data from the surveys being compared, the time alignment of reference horizons and then detecting time shifts between near and far offset traces.

The principles of the present invention are based on the process of imaging the original and repeated seismic survey data through the process of migration. The process of migration will use multiple sound sources and multiple receivers (both in the 1000's or more) optimally located to illuminate subsurface targets to generate the subsurface image of material discontinuities.

For production seismic processing, the wave equation used for migration is generally the acoustic constant density wave equation. What makes migration methods different is the way this equation is numerically solved in the computer. The physics of the imaging problem is either based on propagating the back-scattered recorded waves downward in depth or backward in time. Moving downward depth interval by depth interval necessitates a wave field downward continuation technique, with the recorded data serving as a boundary condition. Marching backward in time uses a wave field extrapolation technique, and the recorded back-scattered data serve as an initial condition.

The principles of the present invention use the data as recorded directly or after calibration corrections are done as pre-processing. The common practice of CDP (common depth point, or more accurately, common midpoint CMP) gathering may or may not be used; it may serve as a data processing convenience, but is not required by the methods of the present invention. The procedures of the present invention described herein will use the wave equation directly as part of the comparison process between time-lapse surveys. The procedures of the present invention include (what is known in common practice) both ‘time’ and depth imaging. Seismic data may also be pre-processed into plane waves and used for migration. These can be source, receiver or offset plane wave data. Like CMP gathering, plane wave data are a pre-processing regularization which increases the signal-to-noise ratio of the data. This plane wave decomposition is a convenient pre-processing step, but is not required by the methods of the present invention.

Any pre-stack migration method can be employed in the methods of the present invention. These include but are not limited to: phase shift, split-step Fourier, phase shift plus interpolation, Kirchhoff and Gaussian beams, implicit and explicit finite differences, among others.

The phase shift method and its two variants are described herein for ease of understanding the principles of the present invention. These methods are not required to be implemented in order to practice the principles of the present invention. For the phase shift method, vertical wave numbers are defined and both the source and receiver data are downward continued depth-by-depth and frequency-by-frequency and then the resulting complex wave fields are deconvolved (in time). That is, the receiver wave field is divided by the source wave field at each frequency and at each position, and the result summed over frequency to form the image. In practice, the wave fields are often simply correlated (in time). That is, the receiver and the complex conjugate of the source wave field are complex multiplied at each frequency and then all frequency components summed to generate the image at each depth, since complex division in the frequency domain can be an unstable process.

The constant velocity limitation of the phase shift method can be circumvented using two variants of the methods of the present invention either alone or in combination. Phase shift plus interpolation (PSPI), works by propagating the source and receiver wave fields across each layer Δz using several constant velocities. The image is again constructed when the data are in the frequency space domain by Fourier division (or by complex conjugate multiplication) of these wave fields and summing all frequency components at each depth.

The split-step Fourier method is based on solving the wave equation after defining the variation of the actual slowness in each depth layer as a perturbation from the mean slowness in that layer. The result is that a single reference vertical wave number (usually based on the mean slowness in the depth interval) is applied via a phase shift to the wave field. The phase-shifted result is then Fourier transformed back to space coordinates, and a second phase shift based on the spatially variable slowness perturbations is applied.

The combination of these two approaches (split-step Fourier and PSPI) is generally used in production seismic imaging.

All migration methods: Kirchhoff, Gaussian beam, implicit and explicit finite difference, reverse time migration, RTM, among others, can be used in connection with the principles of the present invention, but the above three methods, phase shift, split-step Fourier and PSPI (or combinations of all) lend themselves to the disclosure of the present invention with minimal additional mathematical development.

In one embodiment of the present invention, a comparison is made of the amplitude and phase of the data being imaged from the reference and time-lapse surveys for each frequency at each depth.

Ideally, the original and subsequent seismic data surveys should be acquired in as repeatable a manner as technically possible. Pre-processing should include calibration and equalization as necessary to make each survey's data as identical to the other as possible. Time delays, phase shifts and spectral changes due to variability in the acquisition system should all be corrected during the initial pre-processing stages. Even with careful preliminary processing, differences may remain and should be taken into account.

The data can be pre-stack migrated using one of the commonly employed procedures known in the art. In one embodiment, the complex source and receiver wave fields (as a function of frequency, w, and position x, y, z=cl), just above the reservoir zone (herein referred to as the comparison level or cl), is recovered from the original reference seismic and time-lapse seismic data. These wave fields are available at the comparison starting level, z=cl, using the same migration algorithm and using the same velocity structure. This velocity can be spatially variable, v(x, y, z), but the same velocity is used for both the reference and repeat seismic surveys.

At the comparison level, the data being used can be either downward continued or reverse time migrated shot records, CDP (or CMP) gathers or any type of plane wave data. All seismic data organizations and all forms of pre-stack seismic migration can be used in the methods of the present invention. The shot record data can be transformed to plane wave data at the surface or at the comparison level for convenience. The complete source and receiver wave fields (all frequencies and all available spatial positions) from both surveys are available for downward continuation into the zone of interest.

At this point, no matter which migration method was initially employed and for any data type, the methodology details using the PSPI and/or split-step are disclosed herein for convenience. The Fourier method of migration for each interval of depth below the comparison zone, for example, within the reservoir, may be used. (Any other migration method could be employed with the implementation designed to generate the wave fields at the depth levels being compared with respect to the comparison level). It is noted that the depth intervals can be of variable thickness and are not constrained by the depth intervals used above the comparison level.

Again, the same velocity is used for each survey as their data are migrated from the comparison level to each depth interval of interest. This velocity now can be spatially variable or a constant as long as it is the same for each survey being compared. For convenience in describing the methods of the present invention, a constant velocity for each depth interval is used. As an implementation example, the PSPI and/or split-step Fourier method after applying the vertical phase correction, is considered in the wave number domain using the reference slowness for this depth interval. Usually, after transforming to the space domain, a local spatially variable phase shift is applied. This local phase shift for the reference survey (survey 1) is:

Φ₁(w,x,y)=i2πwΔu(x,y)Δz

Where Δu(x, y) are the local slowness perturbations in the interval Δz. After applying the vertical phase shift operators which approximately move the wave fields down one depth level into the comparison (reservoir) zone, the local phase correction of the wave fields should be the sum of several contributions due to the several local slowness contributions:

Φ₁(w,x,y)=φ₁^{s}(w,x,y)+φ₁^{u}^{^{r}}(w,x,y)+φ₁^{u}^{^{f}}(w,x,y)

Where φ₁^{s}(w ,x, y) are the phase contributions of survey 1 which may be due to acquisition, pre-processing, or errors in the overburden velocity used to downward continue the wave field to the reference level

φ₁^{u}^{^{r}}(w,x,y)=i2πwΔu^{r}(x,y)Δz

and

φ₁^{u}^{^{f}}(w,x,y)=i2πwΔu^{f}(x,y)Δz

are due to local slowness differences from the reference slowness attributed to rock properties, Δu^{r}(x, y), and fluid properties, Δu^{f}(x, y), in the interval Δz. The amplitude should be the product

A₁(w,x,y)=a₁^{s}(w,x,y)a₁^{u}^{^{T}}(w,x,y)a₁^{u}^{^{f}}(w,x,y).

In summary, φ₁^{s} is the spatially variable phase of the wave field of the reference survey as a function of frequency, which includes all the phase contributions due to the survey acquisition, the effect of all accumulated velocity errors in the overburden, and any other overburden effects (if any). φ₁^{u}^{^{r}} is the spatially variable phase due to the rock formation slowness within the zone of interest, Δz, at the time of the reference survey and φ₁^{u}^{^{f}} is the spatially variable phase contribution due to the fluids at the time of the reference survey in the same interval. Similarly, the amplitude component, A₁ has components aₗ^{s}, a₁^{u}^{^{r}} and a₁^{u}^{^{f}} due to the same causes.

The time-lapse survey, e.g., the second survey, would have a similar phase:

Φ₂(w,x,y)=φ₂^{s}(w,x,y)+φ₂^{u}^{^{r}}(w,x,y)+φ₂^{u}^{^{f}}(w,x,y)

and amplitude

A₂(w,x,y)=a₂^{s}(w,x,y)a₂^{u}^{^{r}}(w,x,y)a₂^{u}^{^{f}}(w,x,y).

The receiver wave fields are now divided by the source wave fields to form the pre-image wave fields, I(w, x, y, z=cl), for each time-lapse survey. (In practice, the complex receiver wave field may alternatively be multiplied with the conjugate of the source wave field, which is numerically stable but does not contain the correct amplitude information. Either implementation is included here as it is the phase differences that are of primary interest).

The image wave fields are compared at each spatial location by dividing the time-lapse pre-image wave field, I₂ (w, x, y, z=cl) by the reference pre-image wave field, I₁(w, x, y, z=cl). This is the equivalent of deconvolving these wave fields in the time domain and is analogous to the usual wave field imaging condition where the receiver and source wave fields are divided to construct the image. The source and receiver wave fields of each survey have already been used after the downward continuation process to construct the wave fields to be compared, I₁ and I₂. (In practice the complex image wave field may alternatively be multiplied with the conjugate of the time-lapse image wave field, which is numerically stable but does not contain the correct amplitude information. Again, either implementation is included herein as it is the phase differences that are of primary interest). So by comparing the time-lapse and original pre-image wave fields we have in this case:

$$C ( ω , x , y , z = cl ) = \frac{{I}_{2} ( ω , x , y , z = cl )}{{I}_{1} ( ω , x , y , z = cl )} ,$$

which in polar coordinates is:

$$C ( ω , x , y , z = cl ) = \frac{{A}_{2} ( ω , x , y , z = cl )}{{A}_{1} ( ω , x , y , z = cl )} {e}^{i [ {Φ}_{2} ( ω , x , y ) - {Φ}_{1} ( ω , x , y ) ]} ,$$

In order to determine the phase differences, the complex logarithm is now taken,

Ĉ(w,x,y,z=cl)=lnA₂(w,x,y,z=cl)=lnA₁(w,x,y,z=cl)+i[Φ₂(w,x,y)−Φ₁(w,x,y)]

It is recalled from complex cepstrum based homomorphic deconvolution that a straightforward numerical implementation based on the complex logarithm of the original image wave fields before comparison is difficult since only the principal value of the phase is known and phase unwrapping is numerically difficult due to low spectral power points. So, the complex division is computed for each frequency by complex multiplication of the time-lapse wave field, I₂(w, x, y, z=cl), with the complex conjugate of the reference wave field, I₁^{*}(w, x, y, z=cl), and then the difference of the log of their respective amplitude spectra is taken. Let the desired result be

Ĉ(w,x,y,x=cl)=ΔlnA(w,x,y,z=cl)+iΔΦ(w,x,y,z=cl)

where Δln A(w, x, y, z=cl) is the difference of the log amplitude spectra and ΔΦ(w, x, y, z=cl) is the phase difference between the reference and time-lapse wave fields at the reference level. These are obtained in two separate steps. First, let

CC(w,x,y,z=cl)=I₂(w,x,y,z=cl)I₁^{*}(w,x,y,z=cl)=A₂(w,x,y,z=cl)A₁(w,x,y,z=cl)e^{i[Φ}^{₂}^{(w,x,y)-Φ}^{₁}^{(w,x,y)]}

then the phase difference, ΔΦ(w, x, y, z=cl), is obtained using the complex logarithm

ΔΦ(w,x,y,z=cl)=Im(ln(CC(w,x,y,z=cl))).

The log amplitude spectra differences are computed directly from the individual amplitude spectra:

ΔlnA(w,x,y,z=cl)=lnA₂(w,x,y,z=cl)−lnA₁(w,x,y,z=cl).

The expected phase differences should be small. By forming the comparison in the above way, it is not required to numerically determine the phase of each wave field (which may be quite large) first and then subtract to find their difference. Rather, the conjugate is complex multiplied and then numerically determine the phase of the difference directly, which should be a small quantity. This is important as only the principal value of the phase is numerically available (i.e., it is computed modulo 2π) and phase unwrapping would be necessary to compute the phase difference correctly. Even if phase unwrapping proves necessary, it is now a much less difficult task since the phase differences will be smaller than the original phase, and in two dimensions, more stable numerical algorithms exist for this purpose.

The phase differences at the comparison level are now:

$$ΔΦ ( ω , x , y , z = cl ) = [ {φ}_{2}^{s} ( ω , x , y , z = cl ) - {φ}_{1}^{s} ( ω , x , y , z = cl ) ] + [ {φ}_{2}^{{u}^{r}} ( ω , x , y , z = cl ) - {φ}_{1}^{{u}^{r}} ( ω , x , y , z = cl ) ] + [ {φ}_{2}^{{u}^{f}} ( ω , x , y , z = cl ) - {φ}_{1}^{{u}^{f}} ( ω , x , y , z = cl ) ] ,$$

while the log amplitude differences are:

$$Δ ln A ( ω , x , y , z = cl ) = [ ln {a}_{2}^{s} ( ω , x , y , z = cl ) - ln {a}_{1}^{s} ( ω , x , y , z = cl ) ] + [ ln {a}_{2}^{{u}^{r}} ( ω , x , y , z = cl ) - ln {a}_{1}^{{u}^{r}} ( ω , x , y , z = cl ) ] + [ ln {a}_{2}^{{u}^{f}} ( ω , x , y , z = cl ) - ln {a}_{1}^{{u}^{f}} ( ω , x , y , z = cl ) ] ,$$

and these should be small because the data has been pre-processed to make the data of the two surveys as identical as possible. Furthermore, we are still above the reservoir zone, and the geomechanical changes (if any) should also be small. Additionally, since we are above the reservoir, the changes in phase due to fluid changes should be zero.

Thus, ΔA(w, x, y, z=cl) and ΔΦ(w, x, y, z=cl) should principally contain the amplitude and phase differences due to data acquisition differences and geomechanical changes (if any). I₂(w, x, y, z=cl), I₁(w, x, y, z=cl), ΔA(w, x, y, z=cl) and ΔΦ(w, x, y, z=cl) are now saved for future reference as the wave fields of each survey are extended into the zone of interest.

If differences do exist, these reference wave fields can be normalized at the comparison level with respect to one another. As an example, consider the simple case of a single constant reference velocity and the spatial phase correction. Once the data are transformed back to the spatial domain after applying the operator using the reference velocity in the wave number domain, the second phase correction term could now be applied to correct for the lateral velocity variations. The time-lapse pre-image wave field could now incorporate the phase differences found to normalize this wave field to the original survey's pre-image wave field. Whether this correction is incorporated or not depends on whether absolute or relative changes with respect to the comparison level are of interest. This is described in detail below.

A description of the absolute time lapse comparison methodology is now provided below.

If the overlying formation rocks have not changed (due to a geomechanical change) and the surveys have been properly calibrated and equalized, and the fluids in the reservoir have not changed, then the phase difference between the time-lapse image wave fields I₁ and I₂, at and above the reference level, z=cl, should be close to zero.

Just as in the case of the reference level described above, the source and receiver wave fields are imaged for both surveys by downward continuing the source and receiver wave fields of each survey using the same constant velocity for each. At the next depth level, I(w, x, y, z=cl+Δz) is obtained at the depth cl+Δz. The two pre-image wave fields I₂(w, x, y, z=cl+Δz) and I₁(w, x, y, z=cl+Δz) are divided or complex conjugate multiplied. The phase differences at a depth Δz below the comparison level are now:

$$ΔΦ ( ω , x , y , z = cl + Δ z ) = [ {φ}_{2}^{s} ( ω , x , y , z = cl + Δ z ) - {φ}_{1}^{s} ( ω , x , y , z = cl + Δ z ) ] + [ {φ}_{2}^{{u}^{r}} ( ω , x , y , z = cl + Δ z ) - {φ}_{1}^{{u}^{r}} ( ω , x , y , z = cl + Δ z ) ] + [ {φ}_{2}^{{u}^{f}} ( ω , x , y , z = cl + Δ z ) - {φ}_{1}^{{u}^{f}} ( ω , x , y , z = cl + Δ z ) ] ,$$

while the log amplitude differences are:

$$Δ ln A ( ω , x , y , z = cl + Δ z ) = [ ln {a}_{2}^{s} ( ω , x , y , z = cl + Δ z ) - ln {a}_{1}^{s} ( ω , x , y , z = cl + Δ z ) ] + [ ln {a}_{2}^{{u}^{r}} ( ω , x , y , z = cl + Δ z ) - ln {a}_{1}^{{u}^{r}} ( ω , x , y , z = cl + Δ z ) ] + [ ln {a}_{2}^{{u}^{f}} ( ω , x , y , z = cl + Δ z ) - ln {a}_{1}^{{u}^{f}} ( ω , x , y , z = cl + Δ z ) ] ,$$

Integrating ΔΦ(w, x, y, z=cl+Δz) over frequency results in an estimate of the time delay differences that are not incorporated into the imaging using the same velocity for both the reference and repeat surveys (i.e., ΔΦ is of interest both before and after the integration over frequency). If the surveys are nearly identical (or have been calibrated to make them so), the survey phase difference, φ^{s}−φ₁^{s} should be small and the remaining phase differences should be due to changes in phase due to the rock differences in the depth interval Δz, φ₂^{u}^{^{r}}−φ₁^{u}^{^{r}}, which should be small or zero so that only phase changes due to the fluid changes, φ₂^{u}^{^{f}}−φ₁^{u} ^{^{f}} remain. Ideally:

ΔΦ(w,x,y,z=cl+Δz)˜φ₂^{u}^{^{f}}(w,x,y,z=cl+Δz)−φ₁^{u}^{^{f}}(w,x,y,z=cl+Δz)

while the log amplitude differences are:

ΔlnA(w,x,y,z=cl+Δz)˜lna_{z}^{u}^{^{r}}(w,x,y,z=cl+Δz)−lna_{z}^{u}^{^{f}}(w,x,y,z=cl+Δz)

The imaging and comparison process described herein (obtaining these wave field phase differences) is the best way to determine changes in phase, and consequently, it provides an accurate measure of the time shifts (integral of phase differences with respect to frequency) between surveys due to changes in the fluids in the interval Δz. These can then be related to changes in the velocity in the comparison zone in greater spatial detail and resolution than existing methods.

Furthermore, the log amplitude differences are a better measure of the reflectivity changes between the surveys than any previously disclosed method or methods in practice. This is because when phase shifts are present in the data, they are removed by using the correct (i.e., the total) signal strength. This is not possible when comparing (by subtraction or correlation) already imaged surveys, since the amplitude distortion due to changes in the phase are not reflected correctly in just the real part of the imaged complex wave fields.

The above procedure can be repeated for all surveys available and all depth levels of interest. The next depth level can always be compared with the comparison level (a measure of total change in phase and amplitude with increasing depth) and with the previous level (a measure of the interval changes with depth). The various surveys can be compared between each other and other levels can be used as reference levels. All combinations are of interest depending on the application and are included in embodiments of the present invention. For convenience, the division operation (i.e., deconvolution) of the wave fields is used to define some of these combinations; in all cases the actual implementation follows the procedure described above. Some examples are:

$${C}_{k , l}^{j , j} ( ω , x , y , z = {z}_{j} ) = \frac{{I}_{k} ( ω , x , y , z = {z}_{j} )}{{I}_{l} ( ω , x , y , z = {z}_{j} )} ,$$

which compares survey k at depth zⱼ to survey l at the same depth z=zⱼ. This provides the phase and amplitude differences between the two surveys at the specified depth, zⱼ. Another example is

$${C}_{k , l}^{j , cl} ( ω , x , y , z = {z}_{j} ) = \frac{{I}_{k} ( ω , x , y , z = {z}_{j} )}{{I}_{l} ( ω , x , y , z = cl )} ,$$

which compares the survey k at depth zⱼ to survey l at depth z=cl. This provides the total phase and amplitude differences between survey k at depth zⱼ to the reference survey at depth cl. Also

$${C}_{k , l}^{j , i} ( ω , x , y , z = {z}_{j} ) = \frac{{I}_{k} ( ω , x , y , z = {z}_{j} )}{{I}_{l} ( ω , x , y , z = {z}_{i} )} ,$$

which compares the survey k at depth zⱼ to survey l at depth z=zᵢ. This provides the interval phase and amplitude differences between survey k at depth zⱼ to the reference survey at depth zᵢ.

The real part of comparison function, C, is a direct measure of where the phase differences are small, and the imaginary part is a direct measure of where the phase differences are large.

Furthermore, any one of these changes in the x and y direction can be compared by first doing the comparison described herein and then taking the spatial derivatives of the resulting phase and log amplitudes. This provides a measure of the horizontal stretch or shrinkage, which can be related to changes in stress between survey intervals. All subsequent measures derived from the methodology using the principles of the present invention are included in embodiments of the present invention.

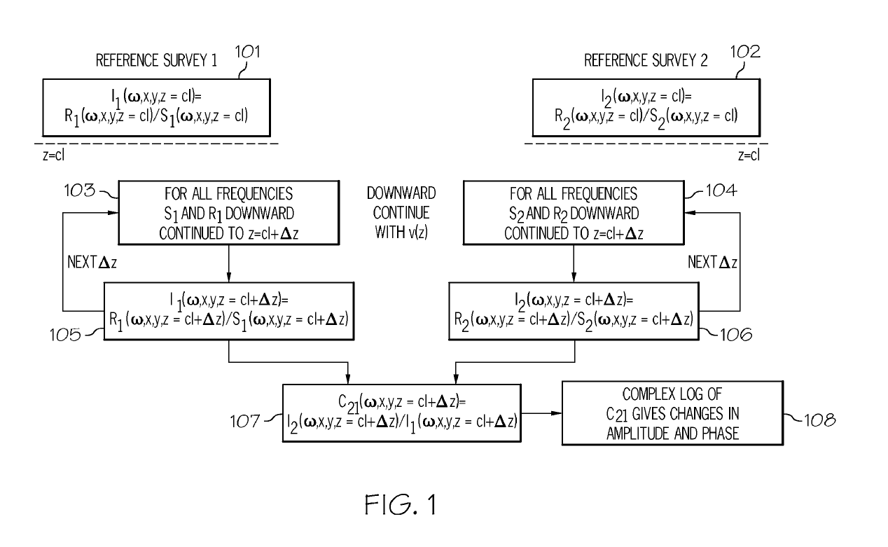

A schematic drawing illustrating the absolute comparison process discussed above is provided in connection with FIG. 1. Referring to FIG. 1, FIG. 1 illustrates the absolute comparison process between two repeated seismic surveys in accordance with an embodiment of the present invention. In this case, the survey acquisition parameters are assumed to be nearly identical or made so after pre-processing. The pre-image wave fields above the reference level are not used as a normalizing function. Instead, the results of downward continuing 103, 104 the source, S, and receiver, R, wave fields 101, 102 for each survey and then forming their pre-imaged wave fields, I, (at z=cl+Δz) 105, 106 are used directly to determine the phase and log amplitude differences between the surveys, C, in step 107. In step 108, the complex logarithm of C results in the amplitude and phase differences directly.

A description of the residual time lapse comparison methodology is now provided below.

If the overlying formation rocks have changed (due to a geomechanical change) and/or the surveys have not been properly calibrated and equalized, then at the comparison level, z=cl, the phase differences between the time-lapse wave fields, I₁ and I₂, will not be zero. That is, phase and amplitude differences due to the data acquisition and changes in the geomechanics of the overburden will exist. The two pre-image wave fields are compared at the comparison (or reference) level I₂(w, x, y, z=cl) and I₁(w, x, y, z=cl) (in practice using the complex conjugate of the reference survey's wave field as described above).

$${C}_{2 , 1}^{cl , cl} ( ω , x , y , z = cl ) = \frac{{I}_{2} ( ω , x , y , z = cl )}{{I}_{1} ( ω , x , y , z = cl )} ,$$

The phase differences at the comparison level are:

ΔΦ(w,x,y,z=cl)=[φ₂^{s}(w,x,y,x=cl)−φ₁^{s}(w,x,y,z=cl)]+[φ₂^{u}^{^{r}}(w,x,y,z=cl)−φ₁^{u}^{^{r}}(w,x,y,z=cl)]

while the log amplitude differences are:

ΔlnA(w,x,y,z=cl)=[lna_{z}^{s}(w,x,y,z=cl)−lna₂^{s}(w,x,y,z=cl)]+[lna₂^{u}^{^{r}}(w,x,y,z=cl)−lna₁^{u}^{^{r}}(w,x,y,z=cl)]

In C_{2.1}(w, x, y, z=cl), the differences in the two surveys are now available for use as a normalizing measure for further comparisons at different depth levels. Unlike the absolute comparison case described above, a relative comparison measure is obtained from the residual phase and amplitude differences between surveys, RC. RC_{2.1}(w, x, y, z=cl+Δz) is now formed, which is the comparison depth of interest, and is divided with the normalized pre-image comparison wave field, C_{2.1}(w, x, y, z=cl)

$${RC}_{2 , 1} ( ω , x , y , z = cl + Δ z ) = \frac{{C}_{2 , 1} ( ω , x , y , z = cl + Δ z )}{{C}_{2 , 1} ( ω , x , y , z = cl )}$$

(Again the implementation method described above is used for a numerically stable result).

The source and receiver wave fields are downward continued for each survey using the same constant velocity for the interval as described above. The resulting phase differences are:

$$R ΔΦ ( ω , x , y , z = cl + Δ z ) = [ {φ}_{2}^{s} ( ω , x , y , z = cl + Δ z ) - {φ}_{1}^{s} ( ω , x , y , z = cl + Δ z ) ] - [ {φ}_{2}^{s} ( ω , x , y , z = cl ) - {φ}_{1}^{s} ( ω , x , y , z = cl ) ] + [ {φ}_{2}^{{u}^{r}} ( ω , x , y , z = cl + Δ z ) - {φ}_{1}^{{u}^{r}} ( ω , x , y , z = cl + Δ z ) ] - [ {φ}_{2}^{{u}^{r}} ( ω , x , y , z = cl ) - {φ}_{1}^{{u}^{r}} ( ω , x , y , z = cl ) ] + [ {φ}_{2}^{{u}^{f}} ( ω , x , y , z = cl + Δ z ) - {φ}_{1}^{{u}^{f}} ( ω , x , y , z = cl + Δ z ) ] - [ {φ}_{2}^{{u}^{f}} ( ω , x , y , z = cl ) - {φ}_{1}^{{u}^{f}} ( ω , x , y , z = cl ) ] ,$$

All data acquisition, pre-processing, and imaging velocity errors at the reference level, z=cl, which contribute to the phase and amplitude contributions, remain the same at z=cl+Δz, so the first two terms within brackets cancel. Also, there are no fluid effects on the phase or amplitude at level z=cl, because it is above the target zone or reservoir, so the expression in the last bracket is zero. The remaining phase contributions are:

$$R ΔΦ ( ω , x , y , z = cl + Δ z ) = [ {φ}_{2}^{{u}^{r}} ( ω , x , y , z = cl + Δ z ) - {φ}_{1}^{{u}^{r}} ( ω , x , y , z = cl + Δ z ) ] - [ {φ}_{2}^{{u}^{r}} ( ω , x , y , z = cl ) - {φ}_{1}^{{u}^{r}} ( ω , x , y , z = cl ) ] + [ {φ}_{2}^{{u}^{f}} ( ω , x , y , z = cl + Δ z ) - {φ}_{1}^{{u}^{f}} ( ω , x , y , z = cl + Δ z ) ] ,$$

Even if there are overburden geomechanical effects, φ₂^{u}^{^{r}}(w, x, y, z=cl), is equal to φ₁^{u}^{^{r}}(w, x, y, z=cl) which results:

RΔΦ(w,x,y,z=cl+Δz)=[φ₂^{u}^{^{r}}(w,x,y,z=cl+Δz)−φ₁^{u}^{^{r}}(w,x,y,z=cl+Δz)]+[φ₂^{u}^{^{f}}(w,x,y,z=cl+Δz)−φ₁^{u}^{^{f}}(w,x,y,z=cl+Δz)],

which contains the change in phase due to fluid changes and geomechanics only in the reservoir zone between level z=cl+Δz and the reference level z=cl which have occurred during the time-lapse interval. Finally, if there are no geomechanic changes during the time-lapse interval in the reservoir, the changes in the phase due to the fluid changes between time-lapse surveys only remain:

RΔΦ(w,x,y,z=cl+Δz)=[φ₂^{u}^{^{f}}(w,x,y,z=cl+Δz)−φ₁^{u}^{^{f}}(w,x,y,z=cl+Δz)]

The log amplitudes follow an exactly analogous development and are not explicitly stated herein for the sake of brevity. For the case of only fluid changes the result is:

ΔlnA(w,x,y,z=cl+Δz)=lna₂^{u}^{^{f}}(w,x,y,z=cl+Δz)−lna₁^{u}^{^{f}}(w,x,y,z=cl+Δz)]

The residual phase differences, formed from the comparison of pre-imaged wave fields of each survey, and then compared to a comparison of the pre-imaged wave fields at a reference level is the optimal way to determine changes in phase and consequently measure the time shifts (integral of phase differences with respect to frequency) between surveys due to changes in the fluids in the interval Δz in the presence of phase differences in the seismic survey and/or geomechanical changes in the overburden. That is, a pre-imaged wave field comparison between surveys at a depth of interest inside the target or reservoir zone compared to the pre-imaged wave field comparison at a level above the reservoir zone results in detailed spatial information, amplitude and phase.

Again, once these basic comparison measures have been formed, their real and imaginary parts can be analyzed as described above. They can be compared between various time-lapse surveys and between different depths levels to get interval results, and spatial derivatives or other derived measures can be formed. Just as in the absolute comparison described above, all combinations of: depth levels, time lapse surveys, their spatial derivatives and other measures derived from the amplitude and phase resulting from this methodology using the principles of the present invention are included in embodiments of the present invention.

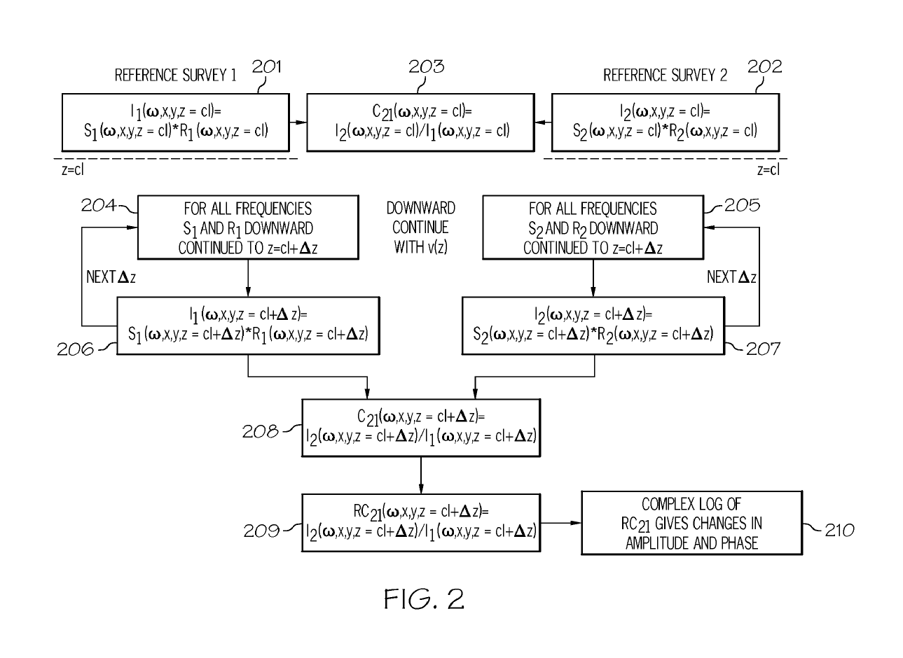

A schematic drawing illustrating the residual time lapse comparison process discussed above is provided in connection with FIG. 2. Referring to FIG. 2, FIG. 2 illustrates the residual comparison process between two repeated seismic surveys in accordance with an embodiment of the present invention. In this case, the survey acquisition parameters are assumed to be different and/or geomechanical effects are present in the overburden. This makes a direct comparison difficult since these effects will be manifest in the differences in the amplitude and in the phase of the surveys. The comparison of the image wave fields at the reference level, C(w, x, y, z=cl) 203 are now used as a normalizing function. The results of downward continuing 204, 205 the source, S, and receiver, R, wave fields 201, 202 of each survey and then forming their imaged wave fields, I (at z=cl+Δz) 206, 207, are now used to form the comparison wave field, C(w, x, y, z=cl+Δz) 208, which is then compared with the comparison wave field at the reference level to determine the residual phase and amplitude differences, RC, between the two surveys in step 209. In step 210, the amplitude and phase differences are obtained directly by taking the complex logarithm of RC.

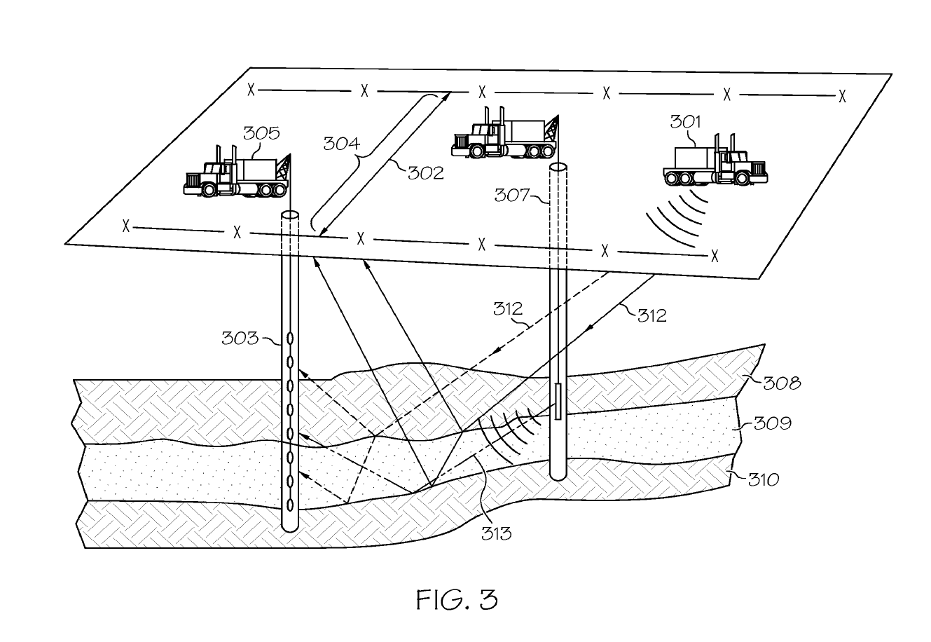

A drawing illustrating schematically the basic principles used in seismic acquisition is provided in connection with FIG. 3 in accordance with an embodiment of the present invention. Referring to FIG. 3, a surface source 301 transmits either an impulsive or a swept frequency seismic signal (source 301 generates seismic waves 312) where the swept frequency could be selected according to the subsurface mapping targets.

For example, an 8 Hz to 100 Hz impulsive or swept frequency signal could be selected. The reflected seismic signals, which are generated due to the reflected energy from the acoustic impedance contrasts, are received by a surface array 302, downhole array 303 located in well 304, or any combination of the two. The received reflected seismic signals are recorded by recording truck 305. The seismic reflection recording of the reservoir formations can also be made using a downhole source 306 (source 306 generates seismic wave 313 in FIG. 3) located in well 307. The output of downhole source 306 is received by receiver array 303 in well 304 and/or surface array 302. Recording truck 305 is capable of simultaneously recording the data from surface array 302 and downhole array 303. This data acquisition, as shown, can also be done in the marine environment using pressure sources and acoustic towed hydrophone arrays. Both land and marine seismic acquisition data can be done with the equipment available in the industry and the methods for both land and marine seismic type of data acquisition are known in the industry.

FIG. 3 further illustrates, in cross section, reservoir formations 308, 309, 310. Formation 309 is the reservoir rock that has porosity, permeability and pore fluids. Formations 308 and 310 are sealing formations with little porosity and no permeability. Reservoir rock formation 309 is elastically variable and may contain fluids, such as oil, water or gas.

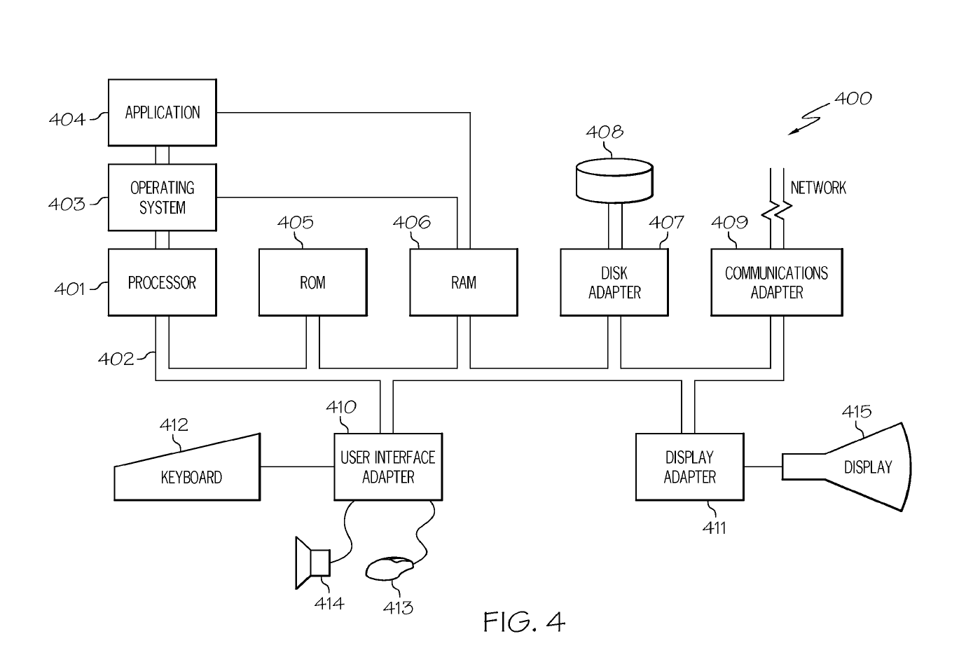

FIG. 4 depicts an embodiment of a hardware configuration of a computer system 400 which is representative of a hardware environment for practicing the present invention.

Turning now to FIG. 4, computer system 400 may have a processor 401 coupled to various other components by system bus 402. An operating system 403 may run on processor 401 and provide control and coordinate the functions of the various components of FIG. 4. An application 404 in accordance with the principles of the present invention may run in conjunction with operating system 403 and provide calls to operating system 203 where the calls implement the various functions or services to be performed by application 404. Application 404 may include, for example, a program for improving the accuracy and detail in determining changes in properties associated with subsurface geological structures using time-lapse seismic data, as discussed herein.

Referring to FIG. 4, read-only memory (“ROM”) 405 may be coupled to system bus 402 and include a basic input/output system (“BIOS”) that controls the code of certain basic functions of computer device 400. Random access memory (“RAM”) 406 and disk adapter 407 may also be coupled to system bus 402. It should be noted that software components including operating system 403 and application 404 may be loaded into RAM 406, which may be computer system's 400 main memory for execution. Disk adapter 407 may be an integrated drive electronics (“IDE”) adapter that communicates with a disk unit 408, e.g., disk drive. It is noted that the program for improving the accuracy and detail in determining changes in properties associated with subsurface geological structures using time-lapse seismic data, as discussed herein, may reside in disk unit 408 or in application 404.

Referring again to FIG. 4, computer system 400 may further include a communications adapter 409 coupled to bus 402. Communications adapter 409 may interconnect bus 402 with an outside network (not shown) thereby allowing computer system 400 to communicate with other similar devices.

I/O devices may also be connected to computer system 400 via a user interface adapter 410 and a display adapter 411. Keyboard 412, pointing device (e.g., mouse) 413 and speaker 414 may all be interconnected to bus 402 through user interface adapter 410. Data may be inputted to computer system 400 through any of these devices. A display monitor 415 may be connected to system bus 402 by display adapter 411. In this manner, a user is capable of inputting to computer system 400 through keyboard 412 or pointing device 413 and receiving output from computer system 400 via display 415 or speaker 414.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” or FORTRAN programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

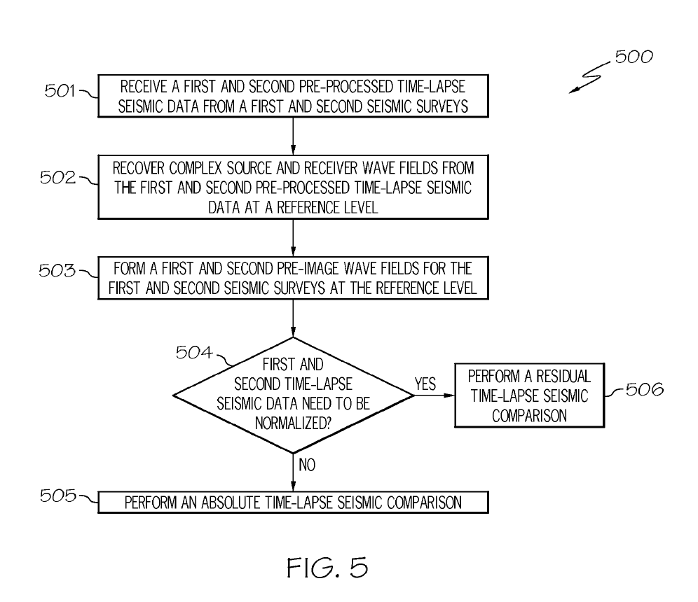

A method for improving the accuracy and detail in determining changes in properties associated with subsurface geological structure using time-lapse seismic data using the principles of the present invention is discussed below in connection with FIG. 5.

FIG. 5 is a flowchart of a method 500 for improving the accuracy and detail in determining changes in properties associated with subsurface geological structure using time-lapse seismic data in accordance with an embodiment of the present invention.

Referring to FIG. 5, in conjunction with FIGS. 1-4, in step 501, a first and a second pre-processed time-lapse seismic data is received from a first and a second seismic survey, respectively.

In step 502, complex source and receiver wave fields are recovered from the first and second pre-processed time-lapse seismic data at a reference level.

In step 503, a first and a second pre-image wave field are formed for the first and second seismic surveys at the reference level.

In step 504, a determination is made as to whether the first and second time-lapse seismic data need to be normalized. The determination as to whether the time-lapse seismic data need to be normalized depends on whether there is a significant phase difference between the first and second pre-image wave fields and whether there is a significant amplitude difference between the first and second pre-image wave fields. If there is a significant phase and/or amplitude difference between the first and second pre-image wave fields, then the time-lapse seismic data need to be normalized Otherwise, the time-lapse seismic data does not need to be normalized

If the first and second time-lapse seismic data do not need to be normalized, then, in step 505, an absolute time-lapse seismic comparison is performed as discussed above. The absolute time-lapse comparison includes comparing phase and amplitude differences between one or more time-lapse seismic data after downward continuation to a depth level below the reference level with one of the first and second time-lapse seismic data. The reference level is located above a region of interest below the subsurface.

If, however, the first and second time-lapse seismic data need to be normalized, then, in step 506, a residual time-lapse seismic comparison is performed as discussed above. The residual time-lapse seismic comparison includes normalizing one or more time-lapse seismic data at the reference level using a phase and an amplitude difference between the first and second pre-image wave fields to derive a relative comparison measure. Furthermore, the residual time-lapse seismic comprising includes comparing one or more normalized time-lapse seismic data after downward continuation to a depth level below the reference level with one of the first and second time-lapse seismic data. The reference level is located above a region of interest below the subsurface.

Method 500 may include other and/or additional steps that, for clarity, are not depicted. Further, method 500 may be executed in a different order presented and the order presented in the discussion of FIG. 5 is illustrative. Additionally, certain steps in method 300 may be executed in a substantially simultaneous manner or may be omitted.

Additionally, method 500 may use additional time-lapse seismic data sets as a reference to be compared to other time-lapse seismic data in addition to the original seismic data in order to obtain the changes in the fluids, both between time-lapse surveys and the original survey.

Furthermore, method 500 may implement pre-image wave field comparisons with respect to a reference for a zone that does not contain fluids in order to detect geomechanical changes in the rocks during the time-lapse seismic measurements.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for improving the accuracy and detail in determining changes in properties associated with subsurface geological structures using time-lapse seismic data, the method comprising:
receiving a first and a second pre-processed time-lapse seismic data from a first and a second seismic survey;
recovering complex source and receiver wave fields from said first and second pre-processed time-lapse seismic data at a reference level;
forming a first and a second pre-image wave field for said first and second seismic surveys at said reference level; and
performing an absolute time-lapse seismic comparison if said first and second pre-processed time-lapse seismic data do not need to be normalized, wherein said absolute time-lapse comparison comprises comparing phase and amplitude differences between one or more time-lapse seismic data after downward continuation to a depth level below said reference level with one of said first and second pre-processed time-lapse seismic data, wherein said reference level is located above a region of interest below the subsurface.

2. The method as recited in claim 1 further comprising:
using additional time-lapse seismic data sets as a reference to be compared to other time-lapse seismic data in addition to said first and second pre-processed time-lapse seismic data.

3. The method as recited in claim 1 further comprising:
comparing at least one of said first and second pre-image wave fields with respect to a reference for a zone that does not contain fluids.

4. A computer program product embodied in a computer readable storage medium for improving the accuracy and detail in determining changes in properties associated with subsurface geological structures using time-lapse seismic data, the computer program product comprising the programming instructions for:
receiving a first and a second pre-processed time-lapse seismic data from a first and a second seismic survey;
recovering complex source and receiver wave fields from said first and second pre-processed time-lapse seismic data at a reference level;
forming a first and a second pre-image wave field for said first and second seismic surveys at said reference level; and
performing an absolute time-lapse seismic comparison if said first and second pre-processed time-lapse seismic data do not need to be normalized, wherein said absolute time-lapse comparison comprises comparing phase and amplitude differences between one or more time-lapse seismic data after downward continuation to a depth level below said reference level with one of said first and second pre-processed time-lapse seismic data, wherein said reference level is located above a region of interest below the subsurface.

5. The computer program product as recited in claim 4 further comprising the programming instructions for:
using additional time-lapse seismic data sets as a reference to be compared to other time-lapse seismic data in addition to said first and second pre-processed time-lapse seismic data.

6. The computer program product as recited in claim 4 further comprising the programming instructions for:
comparing at least one of said first and second pre-image wave fields with respect to a reference for a zone that does not contain fluids.

7. A system, comprising:
a memory unit for storing a computer program for improving the accuracy and detail in determining changes in properties associated with subsurface geological structures using time-lapse seismic data; and
a processor coupled to said memory unit, wherein said processor, responsive to said computer program, comprises:
circuitry for receiving a first and a second pre-processed time-lapse seismic data from a first and a second seismic survey;
circuitry for recovering complex source and receiver wave fields from said first and second pre-processed time-lapse seismic data at a reference level;
circuitry for forming a first and a second pre-image wave field for said first and second seismic surveys at said reference level; and
circuitry for performing an absolute time-lapse seismic comparison if said first and second pre-processed time-lapse seismic data do not need to be normalized, wherein said absolute time-lapse comparison comprises comparing phase and amplitude differences between one or more time-lapse seismic data after downward continuation to a depth level below said reference level with one of said first and second pre-processed time-lapse seismic data, wherein said reference level is located above a region of interest below the subsurface.

8. The system as recited in claim 7, wherein said processor further comprises:
circuitry for using additional time-lapse seismic data sets as a reference to be compared to other time-lapse seismic data in addition to said first and second pre-processed time-lapse seismic data.

9. The system as recited in claim 7, wherein said processor further comprises:
circuitry for comparing at least one of said first and second pre-image wave fields with respect to a reference for a zone that does not contain fluids.

10. A method for improving the accuracy and detail in determining changes in properties associated with subsurface geological structures using time-lapse seismic data, the method comprising:
receiving a first and a second pre-processed time-lapse seismic data from a first and a second seismic survey;
recovering complex source and receiver wave fields from said first and second pre-processed time-lapse seismic data at a reference level;
forming a first and a second pre-image wave field for said first and second seismic surveys at said reference level; and
performing a residual time-lapse seismic comparison if said first and second pre-processed time-lapse seismic data need to be normalized, wherein said residual time-lapse comparison comprises:
normalizing one or more time-lapse seismic data at said reference level using a phase and an amplitude difference between said first and second pre-image wave fields to derive a relative comparison measure; and
comparing said one or more normalized time-lapse seismic data after downward continuation to a depth level below said reference level with one of said first and second pre-processed time-lapse seismic data;
wherein said reference level is located above a region of interest below the subsurface.

11. The method as recited in claim 10 further comprising:
using additional time-lapse seismic data sets as a reference to be compared to other time-lapse seismic data in addition to said first and second pre-processed time-lapse seismic data.

12. The method as recited in claim 10 further comprising:
comparing at least one of said first and second pre-image wave fields with respect to a reference for a zone that does not contain fluids.

13. A computer program product embodied in a computer readable storage medium for improving the accuracy and detail in determining changes in properties associated with subsurface geological structures using time-lapse seismic data, the computer program product comprising the programming instructions for:
receiving a first and a second pre-processed time-lapse seismic data from a first and a second seismic survey;
recovering complex source and receiver wave fields from said first and second pre-processed time-lapse seismic data at a reference level;
forming a first and a second pre-image wave field for said first and second seismic surveys at said reference level; and
performing a residual time-lapse seismic comparison if said first and second pre-processed time-lapse seismic data need to be normalized, wherein said residual time-lapse comparison comprises:
normalizing one or more time-lapse seismic data at said reference level using a phase and an amplitude difference between said first and second pre-image wave fields to derive a relative comparison measure; and
comparing said one or more normalized time-lapse seismic data after downward continuation to a depth level below said reference level with one of said first and second pre-processed time-lapse seismic data;
wherein said reference level is located above a region of interest below the subsurface.

14. The computer program product as recited in claim 13 further comprising the programming instructions for:
using additional time-lapse seismic data sets as a reference to be compared to other time-lapse seismic data in addition to said first and second pre-processed time-lapse seismic data.

15. The computer program product as recited in claim 13 further comprising the programming instructions for:
comparing at least one of said first and second pre-image wave fields with respect to a reference for a zone that does not contain fluids.

16. A system, comprising:
a memory unit for storing a computer program for improving the accuracy and detail in determining changes in properties associated with subsurface geological structures using time-lapse seismic data; and
a processor coupled to said memory unit, wherein said processor, responsive to said computer program, comprises:
circuitry for receiving a first and a second pre-processed time-lapse seismic data from a first and a second seismic survey;
circuitry for recovering complex source and receiver wave fields from said first and second pre-processed time-lapse seismic data at a reference level;
circuitry for forming a first and a second pre-image wave field for said first and second seismic surveys at said reference level; and
circuitry for performing a residual time-lapse seismic comparison if said first and second pre-processed time-lapse seismic data need to be normalized, wherein said residual time-lapse comparison comprises:
circuitry for normalizing one or more time-lapse seismic data at said reference level using a phase and an amplitude difference between said first and second pre-image wave fields to derive a relative comparison measure; and
circuitry for comparing said one or more normalized time-lapse seismic data after downward continuation to a depth level below said reference level with one of said first and second pre-processed time-lapse seismic data;
wherein said reference level is located above a region of interest below the subsurface.

17. The system as recited in claim 16, wherein said processor further comprises:
circuitry for using additional time-lapse seismic data sets as a reference to be compared to other time-lapse seismic data in addition to said first and second pre-processed time-lapse seismic data.

18. The system as recited in claim 16, wherein said processor further comprises:
circuitry for comparing at least one of said first and second pre-image wave fields with respect to a reference for a zone that does not contain fluids.
